(19) United States
(12) Patent Application Publication
(10) Pub. No.: US 2004/0233504 A1
(43) Pub. Date: Nov. 25, 2004

(54) Optical element with full complex modulation

(76) Inventors: Luiz Goncalves, Sao Carlos (BR); Ronaldo Mansano, Sao Paulo (BR); Giuseppe A. Cirino, Sao Paulo (BR); Patricia S. P. Cardona, Sao Carlos (BR); Patrick B. Verdonck, Sao Carlos (BR)

Correspondence Address: SHAPIRO COHEN, P.O. BOX 3440, STATION D, OTTAWA, ON, K1P6P1, CA

(21) Appl. No.: 10/480,546

(22) PCT Filed: May 14, 2002
(86) PCT No.: PCT/BR02/00070

(30) Foreign Application Priority Data
Jun. 13, 2001 (BR) PI0103248-8

(51) Int. Cl. G02F 1/01

(52) U.S. Cl. 359/277

(57) ABSTRACT

The present invention is related to an optical element that carries out the full complex phase and amplitude modulation of light wave fronts. The phase modulation can be attained by changing the optical pathway (for example, by changing the thickness or introducing a relief upon the optical surface) and the amplitude modulation is carried out by blocking the light pathway, (for example, by reflecting, absorbing, attenuating, blocking, polarizing or changing the polarization of the light.

### DISCLOSURE OF THE INVENTION

The present invention is related to an optical element that carries out the full complex-amplitude modulation of light wave fronts (the full phase modulation and the full amplitude modulation of light wave fronts). More specifically, it is related to a diffractive and/or refractive optical element capable of modulating, filtering or changing both the phase and amplitude of light wave fronts.

One skilled in the art knows the effect obtained by the phase and amplitude modulation of light wave fronts, and knows that an ideal optical element is the one capable of controlling and carrying out the phase and amplitude modulation, thus attaining the full complex modulation of any light wave front or light beam.

Generally, the diffractive optical elements have many applications in the industry, and there is an ever increasing research on improvements in this area. Some of the applications are:

manufacturing of Fresnel micro-lenses;

implementation of light multiplexers and demultiplexers for WDM and DWDM systems;

holographic filters for applications in the recognition of objects and targets;

optical interconnections in computers and microcircuits;

correction of the chromatic aberration and other aberrations in conventional and non-conventional optical systems;

micro-lens arrays for CCD arrays;

implementation of micro-sensors;

beam shaping and correction of laser beams;

diffraction gratings;

couplings between laser and optical fibers;

optical coupling in wave guides;

laser mirrors provided with diffractive elements;

holographic memories—for storing information;

safety holograms for certifying the authenticity of bank notes, cards, documents, labels and any goods or product.

The following references can be cited as examples of the state of the art on elements of full complex modulation:

Articles by Lohmann and Paris (“Binary Fraunhofer holograms generated by computer”, Appl. Opt. 1739-1748 (1967), USA) and by Lohmann and Brown (“Computer-generated binary holograms”, IBM J. Res. Develop., 14, 160-168 (1970), USA) disclose holograms capable of partially generating a wave front having a full complex-amplitude distribution in a restricted area in the reconstruction plan thereof. The said hologram is manufactured through the use of a photographic film, that is, the use of a means, device or material capable of modulating the phase through amplitude modulation. The limitation of this approach is its off-axis reconstruction, or off the center in the reconstruction plan, and the low diffraction efficacy, which is lower than 1%.

B. An article by Chu, Fienup and Goodman (“Multiemulsion on-axis computer-generated hologram”, Appl. Opt 12, 1386-1388 (1973), EUA) discloses the full complex-amplitude modulation of a light front by using the twin layer technique that allows the reconstructions along the optical axis (in the center of the reconstruction plan—“On-axis reconstruction”). In this technique, a photographic film layer having a variable thickness is used to modulate the phase, and another layer is used to modulate the amplitude, by controlling the light absorption at each point in the hologram. The said technique presents three limitations: (i) use of two distinct layers, thus requiring a high accuracy in the alignment so that the correct modulation in each point of the hologram can be attained; (ii) the modulation by absorption can cause an eventual malfunctioning and reduction of the useful life time of the device because the absorption of the incident light itself, even at not too high power levels, can result in the degradation of the absorbing layer, (iii) low accuracy for obtaining the layers that modulate both the phase and amplitude.

C. The document of European Patent EP632.296 discloses a two-phase levels diffractive optical element that modulates both the phase and amplitude of an incident light front, transmitting only a specific percentage of light of the zero order of non-diffracted light, while the rest of the light is diffracted at the first order and higher. The limitation of this invention is the restriction that the phase modulation can assume only values between 0 and π (180°), not reaching values between π (180°) and 2π (360°).

Such disclosures show diffractive optical elements of an acceptable but limited performance obtained through expensive manufacturing techniques, for example, laser ablation, electron beam lithography, micro- and nano-machining.

One of the objects of the present invention comprises diffractive or refractive optical elements capable of the simultaneous phase and amplitude modulation of light wave fronts, with an advantageous cost/benefit ratio in the performance not known in the prior art. Still another object of the invention is the process for producing such optical elements.

The optical elements of the invention are diffractive and/or refractive and their operation is based on the transmission or reflection of light. Such elements are capable of modulating, filtering or changing simultaneously, as a single part, the phase and amplitude of light wave fronts. In view of its features, the optical elements of the invention can simultaneously (a) attenuate the amplitude of the wave from 0 to 1, that is, between 0 and 100%, with respect to areas where the light is not blocked and (b) delay the wave phase from 0 to 2π (or from 0 to the multiples 4π, 6π, 8π. . . ), that is, between 0 and 100% of the maximum phase modulation, by changing the thickness of the optical material the light wave front passes through.

Therefore, the invention is related to optical elements characterized by comprising simultaneously a change in the light pathway and areas that block or attenuate the light wave fronts.

In simple terms, the change in the light pathway provides the phase modulation, and the blocking areas provide the amplitude modulation.

As used in the context of the invention, the term “that block the light wave fronts” means the capacity of said optical element to change the amplitude of the light wave front. Such amplitude changes encompass, without excluding any other alternative, a means to (a) reflect, and/or (b) absorb or to attenuate and/or (c) block the light and/or (d) polarize the light/change the polarization.

As used herein, the term “light wave front” means any length of a light wave, visible or not, coherent or not, polarized or not. Except when stated otherwise, any reference to “light”, in the context of the invention, is included in this definition.

Except when stated otherwise, any mention to the “optical element” means either an optical material itself or an optical surface.

A suitable way to change the light pathway, thus providing the phase modulation in an optical element of the invention, when the light is transmitted or reflected, is a change in the thickness of its substrate, or the relief geometry distributed over an optical surface. Another suitable way to change the light pathway, when the optical element of the invention is operated through transmission of right, is when the phase modulation is attained by the change of the refractive index (n), which change is obtained by any means, operation or optical or electronic-optical effect, that follows the geometry of the surface of an optical material. Theoretically, a diffractive optical element that modulates the phase, such as a diffraction-grating-, for example, can attain a diffraction efficiency of 100%.

As is known by one skilled in the art, a solution that which may result in a high diffraction efficiency and easy manufacturing, is a diffractive optical element having a geometry on the optical substrate with several phase levels (2, 4, 8, 16, and so on). The higher the number of phase levels, the greater/closer the approach to the continuous phase profile, and consequently the higher the diffraction efficiency. Such multi-level phase elements can be manufactured by using processes and techniques well established in the industry of semi-conducting micro-devices (photolithography, plasma etching, etc.). Several methods for the calculation and processes for the manufacturing of diffractive optical elements are reported in “Difractive Optics for Industrial and Commercial Applications”, by Turunen and Wyrowski, editors, Akademie Verlag, 1997, showing equations, numerical methods and processes for the calculation, design and manufacturing of multi-level phase diffractive optical elements, with a discontinuous variation, or elements with a continuous variation in the surface relief.

The relief distribution in optical surfaces aiming the phase modulation is known in the art, as well as the process for the production thereof, for example, as disclosed in U.S. Pat. No. 4,895,790.

The relief distribution in this invention may contain 2, 4, 8, 16 or more discrete phase levels, by using for example photolithography and plasma etching techniques. For an optical element that operates with transmitted light, the difference in the substrate path length for each phase level is given by the relationship λ/[m(n−1)], where λ is the light wave length, n is the refractive index of the optical material, and m is the discrete number of phase levels. The distribution of relieves also can be continuous by using such manufacturing processes as laser ablation, electron beam lithography, micro- and nano-machining, which processes are encompassed by the invention. One skilled in the art knows that the distribution of relieves can be determined by considering the phase distribution to be generated. The phase distribution is calculated by mathematical and numerical methods that describe the light propagation. In this process, the characteristics of the optical material, the desired light distributions, and the manufacturing processes used are considered, for example, as referred to in “Difractive Optics for Industrial and Commercial Applications”, by Turunen and Wyrowski, editors, Akademie Verlag, 1997.

The amplitude modulation of the optical element of the invention is attained and controlled by opening windows or areas in a material deposited on the optical surface, which material is capable of, for example, reflecting, absorbing, blocking, polarizing or changing the light polarization, in an alternative or cumulative way. By varying the dimensions of such areas or openings in the material deposited on the optical surface, the local amplitude modulation of the incident wave between 0 and 1 can be attained. Within a variant embodiment of the invention, the amplitude modulation also can be effected by varying the absorption of a material, in such a way that the light amplitude can be attenuated between 0 and 1 (0 to 100%) by controlling the absorption of light between 100 and 0%.

The coating of the optical element, provided with windows or areas that allow the passage of the light and modulate its amplitude, can be comprised of suitable materials such as gold, aluminum, chromium, nickel-chromium, copper, tin, molybdenum, niobium, silicon, silicon dioxide, silicon nitride, composites, compounds, polymers, alloys or the like known to one skilled in the art. Within a particular embodiment of the invention, when said coating is reflective, the risk of actual damages caused by, for example, excessive laser radiation when the optical element is put in operation with a high power laser, can be prevented. Since the coating layer is reflective, substantially no light absorption is involved in the process, therefore the non-modulated light is reflected from the optical element.

The windows or openings that modulate the light have dimensions varying from 0 to the dimensions of the structures used in the element (pixels). The shape of the openings of the windows can be arbitrary, the squared or rectangular shape being particularly suitable with respect to the easiness in the design and manufacturing of the element.

The process for depositing a layer that blocks the light on the surface of the optical element of the invention, can be any process. The thermal evaporation process as well as any process that generates a coating layer is suitable, for example, as described in “VLSI Technology”, edited by S. M. Sze, chapter 9: Metallization, p. 347, McGraw Hill 1983.

With regard to the state of the art, the optical elements of the invention have a better performance in the applications where the high definition of images is important, for example, the projection of high quality images for the construction of holographic displays, laser beam shaping in high power systems and the correction of aberrations in optical systems. The optical elements of the invention, for example, with large areas, are obtained through simpler and cheaper methods than those that currently require highly sophisticated equipment and processes found in the optics industry such as, for example, laser ablation.

The optical elements of the invention last longer than the photographic films used for the implementation of the full complex modulation in the article by Chu, Fienup and Goodman (“Multiemulsion on-axis computer-generated hologram”, Appl. Opt. 12, 1386-1388 (1973), USA), because they are made of inorganic materials.

Although aluminum, gold and the like are quite suitable to be deposited on the optical surface, thus blocking the passage of the light, other more resistant metallic materials such as chromium or nickel-chromium are suitable too. Further, the phase modulation can be implemented with the aid of a carbon film type coating (DLC, or “diamond-like carbon”) that possesses an excellent strength and hardness. When hard metals such as chromium and nickel-chromium are used, it is possible to construct optical elements with an excellent chemical and mechanical strength, thus favoring the light transmittance in the infrared light region, for said materials do not absorb water.

Another object of the invention comprises processes for producing optical elements having the features described above, characterized by comprising the following steps:

changing the light pathway;

providing at least one layer for blocking the light wave fronts on the optical surface;

providing openings in the blocking layer.

Particularly, the change in the light pathway that brings about the phase modulation can be attained by providing relieves on the optical surface or by changing the refractive index through, for example, the presence of a liquid crystal layer that can be electronically and optically changed between two transparent layers and between polarizers. The amplitude modulation also can be attained by using this technique.

This device can also be used as a photolithography mask for projection printing of fine lines and spaces, used for integrated circuit manufacturing. The final resolution of the contact/proximity printer can be improved by at least a factor of two when compared with the use of conventional photolithography mask. Besides, the dimensions on the mask (the complex modulation DOE), can be several times larger than on the wafer, in this way reducing mask making cost.

### EXAMPLE

A particular example of the embodiment of the invention is given below merely for illustration purposes. It should be understood that said example does not limit the scope of the invention defined in the attached claims.

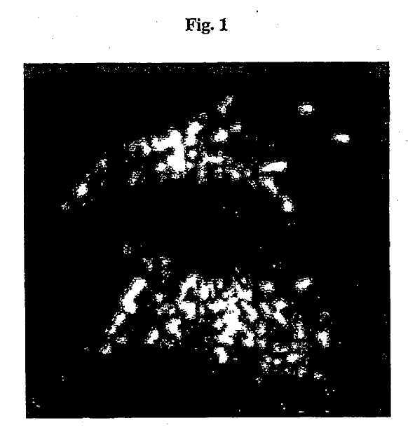

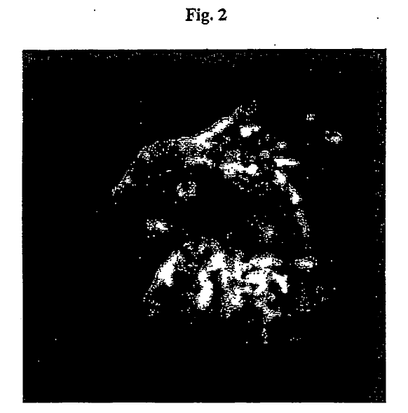

The accompanying figures illustrate the reconstitution of the image of an eagle obtained from holograms according to the prior art (only phase modulation, FIG. 1) and according to the invention (full complex modulation, FIG. 2), with the aid of a common low power helium-neon (He—Ne) laser.

The calculation of the hologram corresponding to FIG. 1 was made by iterative methods of Fourier transform based on IFTA (Iterative Fourier Transform Algorithm), described in the book “Diffractive Optics for Industrial and Commercial Applications”, by Turunen and Wyrowski, editors, Akademie Verlag, 1997. The calculation of the hologram corresponding to FIG. 2 was made by inversely propagating the image in question.

The sequence of manufacture steps of the two holograms with light modulation comprises the steps described below. The image obtained in FIG. 1 corresponds to the hologram of the prior art, obtained by a process corresponding to steps 1 to 5. The image obtained in FIG. 2 corresponds to the hologram obtained by the process of the invention, steps 1 to 9.

The substrate used was a high quality optical glass (Superwhite B270, of the company-SCHOTT GLAS, Geschäftsbereich Optik Optisches Glas, Germany).

1. This substrate was cleaned, initially in a 5 minute bath under a flow of deionized water, followed by a 20 minute bath in ammonium hydroxide/water peroxide/deionized water (1:1:5 ratios, respectively), followed by a rinsing in a flow of deionized water for five minutes.

2. The deposition of a diamond type carbon or DLC (“diamond-like carbon”) film was effected by a cathodic sputtering process, as in the Ph.D. thesis of Marcos Massi, “Deposition and corrosion of diamond type carbon films through plasma-aided techniques”, Escola Politécnica de Universidade de São Paulo, Engenharia Elétrica, Brasil, 1999. For a 1.5 μm thick film, the deposition time was 90 minutes.

3. The lithography for defining the structures on the carbon film comprised the following steps:

dehydration of the substrate with isopropyl alcohol in a spinner at 3,500 RPM for 20 seconds;

application of adhesion promoter HMOS in a spinner at 3,500 RPM for 20 seconds;

application of a photosensitive resin (known as photo resist) OFPR 800 (of the company Tokio Ohka Kogyo Co Ltd., Japan) in a spinner at 3,500 RPM for 20 seconds;

pre-bake of the photo resist on a hot plate for 90 seconds at 105° C.;

exposure to ultraviolet light with an optical aligner at 25 mW/cm² for 20 seconds;

development of the resist in a developing solution AZ MIF-312 (of the company Hoechst GAC, Germany) diluted in deionized water at a 2:1 ratio (developer: water);

rinsing in a flow of deionized water for 40 seconds;

post-bake of the photo resist on a hot plate for 5 minutes at 130° C.,

Now, the sample is ready for the definition of the phase levels.

4. The etching of the DLC film was performed in a single wafer, planar RIE (Reactive Ion Etching) plasma etching equipment described in the article by R. D. Mansano, P. Verdonck, H. S. Maciel, “Anisotropic reactive ion etching in silicon, using a graphite electrodes”, Sensors and Actuators, A, Vol. 6512-3 pp 180-186 (1998).

The conditions of this etching process are as follows:

oxygen plasma, 15 sccm flow,

pressure of 50 mTorr;

RF power of 100 W;

self-polarization voltage of −530V;

This process provides a DLC film etching rate of 266 nm/min, and the process time depends on the height of the relief to be generated. For example, in order to manufacture an element with two phase levels, a 1.76 minute corrosion process is required, considering the refraction index of the DLC film. Since the photo resist etch rate is approximately the same as that of the DLC, it is also possible to implement a continuous relief.

5. After the etching, the photo resist mask is removed by immersing same in acetone at 50° C. for 2 minutes. Then, it is immersed in isopropyl alcohol. Finally, the wafer/substrate is rinsed in deionized water and dried under a nitrogen jet.

Thus, the cycle of embossing/generating two phase levels in the carbon film is finished. Steps 3 through 5 were repeated for obtaining four phase levels.

6. Then, the deposition of the metal is accomplished (performed). In this example, aluminum was thermally evaporated. The thickness of the resulting film was 200 nm.

7. After this step, a new lithography step is repeated on the metallic film. The process is identical to the one described in step 3 except for the exposure time of 12 seconds used in this step.

8. Next, the aluminum film is subjected to etching. This etching can be accomplished either by plasma or on a wet basis. In this example, a mixture of phosphoric acid-nitric acid-deionized water at a 80/5/10 ratio was used.

9. Step 5 for the removal of the photo resist was repeated. This finishes the processing of the full complex modulation device/wafer.

It was noted that the quality of the image reconstructed with the aid of the optical element of the invention shown in FIG. 2, clearly shows a higher quality than the one of the state of the art, shown in FIG. 1.

Other embodiments of the invention will become readily apparent to one skilled in the art from the disclosures contained in this specification, or from the practice of the invention disclosed herein. The purpose of the specification, examples and drawings is to exemplify a suitable way to accomplish the invention, the actual scope of which is determined by the attached claims.

1. Optical element with full complex modulation of light wave fronts characterized by comprising simultaneously at least a change in the light pathway, and areas for blocking the light wave fronts.

2. The optical element according to claim 1, characterized in that said change in the light pathway is attained by means of a change in the thickness of its optical substrate or a distribution of relieves on its optical surface.

3. The optical element according to claim 1, characterized in that said change in the light pathway is attained by changing the refractive index.

4. The optical element according to claim 3, characterized in that the bidimensional change of the refractive index is attained by the presence of a liquid crystal layer inside the optical element

5. The optical element according to claim 1, characterized in that said areas for blocking the light comprise a material deposited on the optical surface of said optical element.

6. The optical element according to claim 5, characterized in that the material deposited on the optical surface of said optical element is capable of reflecting the light and/or absorbing the light and/or blocking the light pathway and/or polarizing the light and/or changing the polarization of the light.

7. The optical element according to claim 5, characterized in that the material deposited on the optical surface of said optical element is capable of reflecting the light pathway.

8. The optical element according to claim 5, characterized in that the material deposited on the optical surface of said optical element is chosen from the group consisting of aluminum, gold, chromium, nickel-chromium, copper, tin, molybdenum, niobium, silicon, silicon dioxide, and silicon nitride.

9. The optical element according to claim 5, characterized in that the material deposited on the optical surface of said optical element is aluminum or gold.

10. The optical element according to claim 5, characterized in that the material deposited on the optical surface of said optical element is provided with openings that allow the passage of the light and modulate its amplitude.

11. The optical element according to claim 10, characterized in that said openings vary between 0 and 100% of the dimensions of the structures used in the element, or pixels.

12. The optical element according to claim 10, characterized in that the amplitude modulation also can be affected by varying the absorption of a material, in such a way that the light amplitude can be attenuated between 0 and 1 (0 to 100%) by controlling the absorption of light between 100 and 0%.

13. The optical element according to claim 10, characterized in that said openings have a square or rectangle shape.

14. A process for producing optical elements with full complex modulation of light wave fronts, characterized by comprising the following steps:
changing the light pathway;
providing at least one layer for blocking the light wave fronts on the optical surface;
providing openings in the blocking layer.

15. The process according to claim 14, characterized in that said change in the light pathway is attained by a change in the thickness of its optical substrate or a relief distribution on its optical surface.

16. The process according to claim 14, characterized in that said change in the light pathway is attained by changing the refractive index.

17. The process according to claim 14, characterized in that said provision of a layer for blocking the light is obtained by cathodic sputtering.

18. The process according to claim 14, characterized in that said provision of openings in said layer for blocking the light is by lithography followed by etching.
